(19) United States
(12) Patent Application Publication
(10) Pub. No.: US 2026/0333072 A1
(43) Pub. Date: Oct. 22, 2026

(54) WIRELESS COMMUNICATION SYSTEM, WIRELESS COMMUNICATION METHOD, WIRELESS COMMUNICATION CONTROL DEVICE AND WIRELESS COMMUNICATION PROGRAM

(71) Applicants: NTT, Inc., Tokyo (JP); NTT DOCOMO, INC., Tokyo (JP)

(72) Inventors: Hayato FUKUZONO, Musashino-shi, Tokyo (JP); Toshifumi MIYAGI, Musashino-shi, Tokyo (JP); Takeshi ONIZAWA, Musashino-shi, Tokyo (JP); Tatsuki OKUYAMA, Tokyo (JP); Satoshi SUYAMA, Tokyo (JP); Yoshihisa KISHIYAMA, Tokyo (JP)

(73) Assignees: NTT, Inc., Tokyo (JP); NTT DOCOMO, INC., Tokyo (JP)

(21) Appl. No.: 19/114,802

(22) PCT Filed: Sep. 27, 2022
(86) PCT No.: PCT/JP2022/036017

§ 371 Date: Mar. 25, 2025

(51) Int. Cl. H04W 24/02; H04W 52/02

(52) U.S. Cl. CPC H04W 24/02; H04W 52/02

(57) ABSTRACT

The wireless communication system includes base stations, a terminal, and a toll center. The terminal is configured to perform calculating a required radio quality. The base stations are configured to perform: first calculation of power consumption by transmitted radio waves; second calculation of power consumption by an analog circuit; and third calculation of power consumption by digital signal processing. The toll center is configured to perform: selecting candidates for a combination of an accommodating base station and a communication scheme; fourth calculation, for each candidate for a combination, of a sum of power consumption by an entire network from results of the first, second, and third calculations; recording a result of the fourth calculation with respect to all of the candidates for a combination; selecting the combination that minimizes the power consumption by the entire network from a result of the recording; and implementing wireless communication using the selected combination.

### TECHNICAL FIELD The present disclosure relates to a wireless communication system, a wireless communication method, a wireless communication control device, and a wireless communication program.

### BACKGROUND ART

In wireless communication systems that include a plurality of base stations, there is a need for techniques that can achieve power savings. One such technique is a technique to optimize power consumption by clustering base stations around a user.

The technique involves clustering a plurality of base stations in the vicinity of a user terminal and having the base stations perform cooperative transmission to optimize frequency utilization efficiency and power consumption by transmitted radio waves.

### CITATION LIST

### Non Patent Literature

Non Patent Literature 1: H. A. Ammar, et al., “User-centric cell-free massive MIMO networks: A survey of opportunities, challenges and solutions,” IEEE Commun. surveys & tutorials, Vol 24, No. 1, First quarter 2022.
Non Patent Literature 2: W. Nie, et al., “User-centric cross-tier base station clustering and cooperation in heterogeneous networks: Rate improvement and energy saving, ”IEEE JSAC, Vol 34, No. 5, May 2016.

### SUMMARY OF INVENTION

### Technical Problem

However, the techniques described above do not take into consideration the power consumption by a network as a whole. In other words, there is a problem in that only the power consumption by the transmitted radio waves is taken into consideration and power consumption such as thermal energy due to analog circuitry and digital signal processing is not taken into consideration.

In addition, the techniques described above do not allow for the study of optimal values that depend on parameters that change over time. In other words, there is a problem in that optimal values cannot be studied with respect to parameters that change in real time including a presence or absence of terminal movement, a communication distance, and a clustering result of a user.

In order to solve the problems described above, a first object of the present disclosure is to provide a wireless communication system that can reduce power consumption with respect to an entire network including a plurality of base stations.

In addition, a second object of the present disclosure is to provide a wireless communication method that can reduce power consumption with respect to an entire network including a plurality of base stations.

Furthermore, a third object of the present disclosure is to provide a wireless communication control device that can reduce power consumption with respect to an entire network including a plurality of base stations.

In addition, a fourth object of the present disclosure is to provide a wireless communication program that can reduce power consumption with respect to an entire network including a plurality of base stations.

### Solution to Problem

A first aspect of the present disclosure is preferably a wireless communication system including: a plurality of base stations, a terminal, and a toll center, wherein the terminal is configured to perform processing of calculating a required radio quality, the base stations are configured to perform: first calculation processing of calculating power consumption by transmitted radio waves; second calculation processing of calculating power consumption by an analog circuit; and third calculation processing of calculating power consumption by digital signal processing, and the toll center is configured to perform: selection processing of selecting candidates for a combination of an accommodating base station and a communication scheme; fourth calculation processing of calculating, for each candidate for a combination, a sum of power consumption by an entire network from results of the first, second, and third calculation processing; recording processing of recording a result of the fourth calculation processing with respect to all of the candidates for a combination; selection processing of selecting the combination that minimizes the power consumption by the entire network from a result of the recording processing; and processing of implementing wireless communication using the selected combination.

A second aspect of the present disclosure is preferably a wireless communication method carried out by a wireless communication system including a plurality of base stations, a terminal, and a toll center, the wireless communication method comprising: a step of calculating a required radio quality; a step of selecting candidates for a combination of an accommodating base station and a communication scheme; with respect to all of the candidates for a combination, a first calculation step of calculating power consumption by transmitted radio waves; a second calculation step of calculating power consumption by an analog circuit; a third calculation step of calculating power consumption by digital signal processing; a fourth calculation step of calculating a sum of power consumption by an entire network from results of the first, second, and third calculation steps; a recording step of recording a result of the fourth calculation step with respect to all of the candidates for a combination; a step of selecting the combination that minimizes the power consumption by the entire network from a result of the recording step; and a step of implementing wireless communication using the selected combination.

A third aspect of the present disclosure is preferably a wireless communication control device that controls a wireless communication system including a plurality of base stations and a terminal, the wireless communication control device being configured to perform: selection processing of selecting candidates for a combination of an accommodating base station and a communication scheme; calculation processing of calculating, with respect to all of the candidates for a combination, a sum of power consumption by an entire network calculated by the accommodating base station; recording processing of recording a result of the calculation processing with respect to all of the candidates for a combination; processing of selecting the combination that minimizes the power consumption by the entire network from a result of the recording processing; and processing of implementing wireless communication using the selected combination.

A fourth aspect of the present disclosure is preferably a wireless communication program to be executed by an arithmetic processor of a wireless communication control device that controls a wireless communication system including a plurality of base stations and a terminal, the wireless communication program causing the wireless communication control device to perform: selection processing of selecting candidates for a combination of an accommodating base station and a communication scheme; calculation processing of calculating, for each candidate for a combination, a sum of power consumption by an entire network; recording processing of recording a result of the calculation processing with respect to all of the candidates for a combination; selection processing of selecting the combination that minimizes the power consumption by the entire network from a result of the recording processing; and processing of implementing wireless communication using the selected combination.

### Advantageous Effects of Invention

According to the first to fourth aspects of the present disclosure, power consumption can be reduced with respect to an entire network including a plurality of base stations.

### BRIEF DESCRIPTION OF DRAWINGS

FIG. 1 is a diagram showing a wireless communication system according to a first embodiment of the present disclosure.

FIG. 2 is a functional block diagram of a wireless communication device according to the first embodiment of the present disclosure.

FIG. 3 is a flowchart showing processing of determining a combination of an accommodating base station and a communication scheme according to the first embodiment of the present disclosure.

### DESCRIPTION OF EMBODIMENTS

### First Embodiment

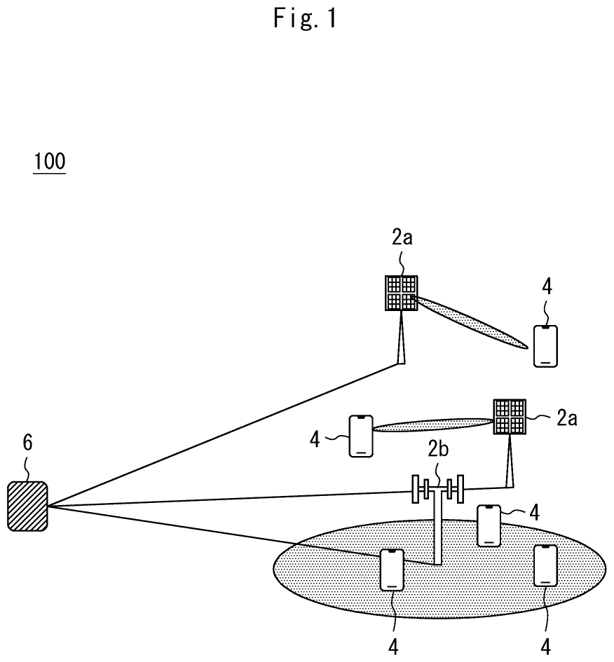

FIG. 1 is a diagram showing a wireless communication system according to a first embodiment of the present disclosure. A wireless communication system 100 includes a plurality of base stations 2a and 2b. The base station 2a is, for example, a base station including an omnidirectional antenna. The base station 2b is, for example, a base station that uses mMIMO (massive Multiple Input Multiple Output).

In addition, the wireless communication system 100 includes a plurality of terminals 4. The terminals 4 may be terminals that include omnidirectional antennas or terminals that use mMIMO.

Furthermore, the wireless communication system 100 includes a toll center 6. The toll center 6 controls the wireless communication system 100 based on information collected from the terminals. Specifically, in order to optimize the power consumption by the entire network, a combination of an accommodating base station and a communication scheme is selected based on calculation results of power consumption by the transmitted radio waves, an analog circuit, and digital signal processing, respectively.

In this case, the power consumption by transmitted radio waves refers to, for example, energy from radio wave emissions. In addition, the power consumption by an analog circuit refers to, for example, thermal energy that can be estimated from an operating state of an amplifier or the like. In this case, the operating state of the amplifier can be estimated from, for example, a backoff value of the amplifier. Furthermore, the power consumption by digital signal processing refers to, for example, thermal energy consumed by calculation processing.

First, the toll center 6 selects candidates for a combination of an accommodating base station and a communication scheme. The selection is performed based on radio quality information assumed by each terminal. In addition, the radio quality information is estimated based on position information and movement speed information collected by each terminal. In this case, it is assumed that each base station and each terminal meet a required throughput.

Based on each candidate for a combination of an accommodating base station and a communication scheme, a corresponding base station 2 calculates power consumption by transmitted radio waves, the analog circuit, and digital signal processing. By comparing results of these calculations, the toll center 6 determines a combination of an accommodating base station and a communication scheme that minimizes power consumption. Base stations that are not selected at this point are put to sleep to reduce the power consumption by the entire network.

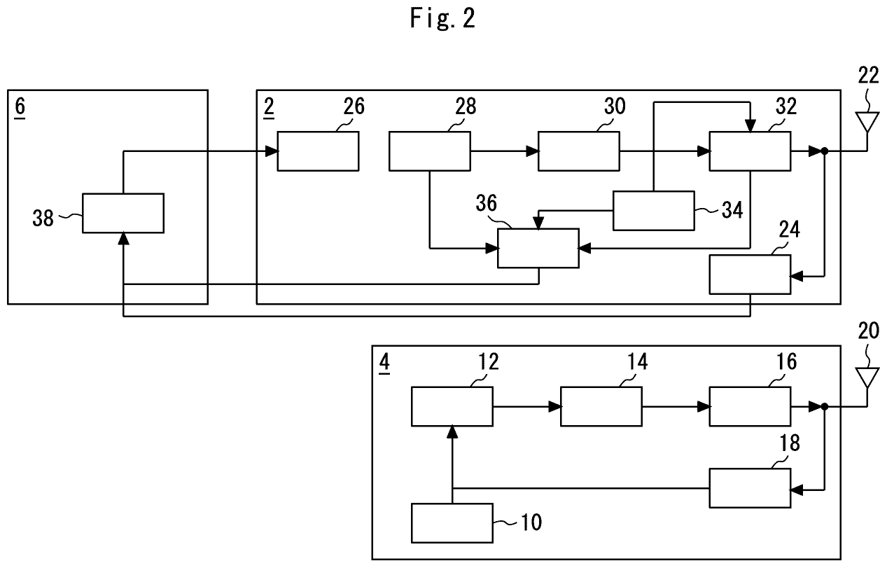

FIG. 2 is a functional block diagram of a wireless communication device according to the first embodiment of the present disclosure. Here, transmission and reception of information when the toll center 6 determines a control method of the wireless communication system 100 based on the information collected from the terminals 4 will be described.

First, a flow of information transmission from the terminal 4 to the toll center 6 will be described. The terminal 4 includes a position information/movement speed calculating unit 10. The position information/movement speed calculating unit 10 calculates position information and a movement speed of the terminal 4 and inputs the calculated position information and movement speed to a digital modulation processing unit 12. In addition, the terminal 4 includes a wireless communication quality estimating unit 18. The wireless communication quality estimating unit 18 estimates a wireless communication quality of the terminal 4 and inputs the estimated wireless communication quality to the digital modulation processing unit 12.

The digital modulation processing unit 12 processes a received signal by digital modulation and transmits the processed signal to a digital/analog converting unit 14. The digital/analog converting unit 14 converts a digital modulation signal into an analog signal and transmits the converted analog signal to an analog circuit unit 16. The analog circuit unit 16 performs processing such as amplification in order to transmit a signal as radio waves. The signal processed by the analog circuit unit 16 is transmitted from an antenna 20 to an antenna 22. Accordingly, information of the terminal 4 is transmitted to the base station 2.

The base station 2 includes a terminal information collecting unit 24. The terminal information collecting unit 24 collects information of each terminal and transmits the collected information to a centralized control unit 38. Information is transmitted from the terminal 4 to the toll center 6 as described above.

Next, a flow in which the toll center 6 selects candidates for a combination of an accommodating base station and a communication scheme and the base station 2 calculates the power consumption for each candidate will be described. The toll center 6 includes the centralized control unit 38. Based on information transmitted from the terminal 4, the centralized control unit 38 selects candidates for a combination of an accommodating base station and a communication scheme. In addition, the centralized control unit 38 transmits information on the candidates to a base station parameter managing unit 26.

The base station parameter managing unit 26 records the information on the candidates for a combination of an accommodating base station and a communication scheme having been transmitted from the centralized control unit 38. Based on base station parameters inputted from the centralized control unit 38, the base station parameter managing unit 26 manages parameters such as transmitted power and modulation schemes of the base station 2. Therefore, the base station 2 will be able to calculate power consumption for each candidate for a combination of an accommodating base station and a communication scheme recorded by the base station parameter managing unit 26.

Finally, a flow in which the toll center 6 determines a combination of an accommodating base station and a communication scheme based on the power consumption calculated by the base station 2 will be described. First, power consumption by transmitted radio waves will be described. The base station 2 includes a transmitted power control unit 34. The transmitted power control unit 34 has a function of defining a signal power to be transmitted and transmitting the defined signal power to an analog circuit unit 32. At the same time, the transmitted power control unit 34 transmits information related to radio wave emission to a power consumption calculating unit 36. The power consumption calculating unit 36 calculates power consumption by transmitted radio waves based on the received information.

Next, power consumption by the analog circuit will be described. The base station 2 includes a digital modulation processing unit 28. The digital modulation processing unit 28 processes a transmission signal by digital modulation and transmits the processed signal to a digital/analog converting unit 30. The digital/analog converting unit 30 converts a digital modulation signal into an analog signal. In addition, the digital/analog converting unit 30 transmits the converted analog signal to the analog circuit unit 32. The analog circuit unit 32 performs processing such as amplification in order to transmit radio waves from an antenna. The analog circuit unit 32 transmits information necessary for power consumption calculation to the power consumption calculating unit 36. The power consumption calculating unit 36 calculates power consumption by the analog circuit based on the received information.

Next, power consumption by digital signal processing will be described. The base station 2 includes the digital modulation processing unit 28. As described above, the digital modulation processing unit 28 converts a digital modulation signal into an analog signal. At the same time, the digital modulation processing unit 28 transmits information related to digital signal processing to the power consumption calculating unit 36. The power consumption calculating unit 36 calculates power consumption by digital signal processing based on the received information.

The power consumption calculating unit 36 performs each power consumption calculation as described above. In addition, the power consumption calculating unit 36 transmits information related to the calculated power consumption to the centralized control unit 38.

The centralized control unit 38 calculates the power consumption by the entire network for each candidate for a combination of an accommodating base station and a communication scheme. In other words, the centralized control unit 38 calculates a sum of power consumption by the transmitted radio waves, the analog circuit, and the digital signal processing. Next, the centralized control unit 38 records the calculated power consumption. The recording is performed with respect to all of the combinations of an accommodating base station and a communication scheme. In addition, the centralized control unit 38 compares the recorded power consumption and selects a combination of an accommodating base station and a communication scheme that minimizes power consumption.

As described above, the combination of an accommodating base station and a communication scheme determined by the centralized control unit 38 is notified to the base station parameter managing unit 26. The wireless communication system 100 can be reduced the power consumption with respect to the entire network by exerting control according to the notification.

Note that the functions related to the toll center 6 according to the present disclosure can also be realized by a computer and a program. The program can be recorded on a storage medium or provided through a network.

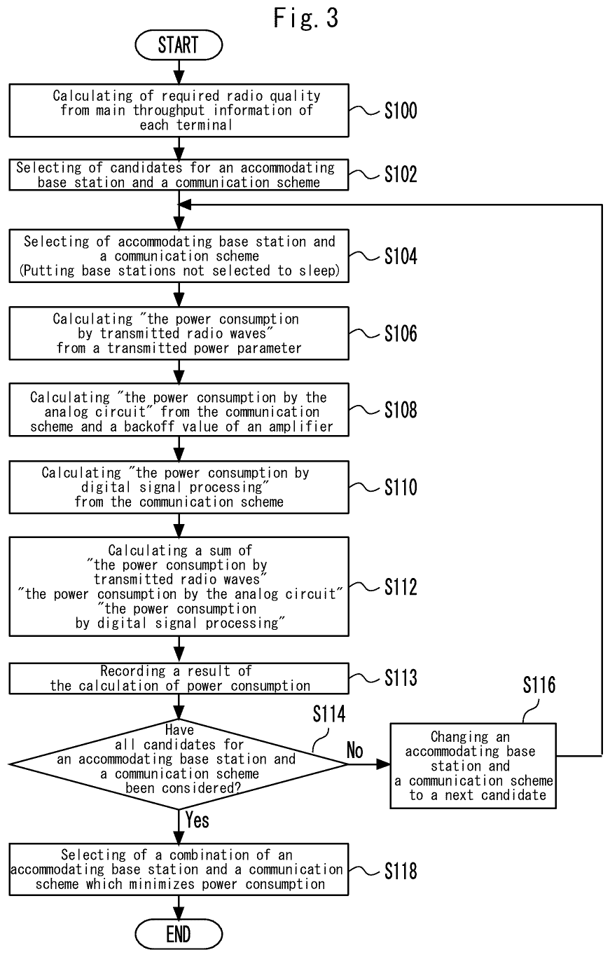

FIG. 3 is a flowchart showing processing of determining a combination of an accommodating base station and a communication scheme according to the first embodiment of the present disclosure. First, in step 100, a required radio quality is calculated from main throughput information of each terminal. The required radio quality is, for example, an SINR. In addition, this processing is performed by, for example, the terminal 4.

Next, in step 102, candidates for an accommodating base station and a communication scheme are selected. This processing is performed based on the required radio quality as well as position information and movement speed of the terminals. In addition, this processing is performed by, for example, the toll center 6.

Next, in step 104, one candidate is selected from the candidate for a combination of an accommodating base station and a communication scheme. Base stations that are not selected at this point are put to sleep to reduce the power consumption by the entire network.

Steps 106 to 110 are steps of calculating the power consumption by each accommodating base station based on the selected combination of an accommodating base station and a communication scheme. This processing is performed by, for example, the base station 2.

First, in step 106, the power consumption by transmitted radio waves is calculated from a transmitted power parameter. The power consumption by the transmitted radio waves is energy due to radio ware emissions.

Next, in step 108, the power consumption by the analog circuit is calculated from the selected communication scheme and a backoff value of an amplifier. The power consumption by the analog circuit is thermal energy.

In addition, in step 110, the power consumption by digital signal processing is calculated from the selected communication scheme. The power consumption by the digital signal processing is thermal energy.

Next, in step 112, a sum of power consumption by the entire network is calculated. In other words, based on the power consumption by transmitted radio waves, the power consumption by the analog circuit, and the power consumption by digital signal processing having been calculated for each accommodating base station, a sum of the power consumptions is calculated. This processing is performed by, for example, the toll center 6.

Next, in step 113, a result of the calculation of power consumption is recorded. This processing is performed by, for example, the toll center 6.

Next, in step 114, whether or not all candidates for a combination of an accommodating base station and a communication scheme have been considered is verified. This processing is performed by, for example, the toll center 6. When all candidates for a combination have been considered, the process advances to step 118. When all candidates for a combination have not been considered, the process advances to step 116.

Next, in step 116, the combination of an accommodating base station and a communication scheme is changed to a next candidate and a return is made to step 104. Accordingly, the power consumption by the entire network can be calculated with respect to all of the candidates selected in step 102. This processing is performed by, for example, the toll center 6.

In step 108, a combination of an accommodating base station and a communication scheme which minimizes power consumption is selected. In other words, the power consumption calculated so far for all candidates for a combination of an accommodating base station and a communication method are compared and a most appropriate candidate is selected. This processing is performed by, for example, the toll center 6. Base stations that are not selected at this point are put to sleep to reduce the power consumption by the entire network.

Performing processing according to this flowchart enables a candidate for a combination of an accommodating base station and a communication method which minimizes the power consumption by the entire network to be selected.

### REFERENCE SIGNS LIST

2, 2a, 2b Base station
4 Terminal
6 Toll center
100 Wireless communication system

1. A wireless communication system comprising a plurality of base stations, one or more terminal, and one or more toll center, wherein
the terminal is configured to perform calculating a required radio quality,
the base stations are configured to perform:
first calculation of power consumption by transmitted radio waves;
second calculation of power consumption by an analog circuit; and
third calculation of power consumption by digital signal circuitry performing digital signal processing, and
the toll center is configured to perform:
selecting candidates for a combination of an accommodating base station and a communication scheme;
fourth calculation, for each candidate for a combination, of a sum of power consumption by an entire network from results of the first, second, and third calculations;
recording a result of the fourth calculation with respect to all of the candidates for a combination;
selecting the combination that minimizes the power consumption by the entire network from a result of the recording; and
implementing wireless communication using the selected combination.

2. The wireless communication system according to claim 1, wherein the toll center is configured to perform putting base station not selected in the selecting to sleep.

3. The wireless communication system according to claim 1, wherein the selecting includes determining the candidates for a combination based on the required radio quality and position information and a movement speed of the terminal.

4. The wireless communication system according to claim 1, wherein the power consumption by the analog circuit is thermal energy that can be estimated from the communication scheme and an operating state of an amplifier.

5. The wireless communication system according to claim 1, wherein the power consumption by the digital signal circuitry is thermal energy that can be estimated from the communication scheme.

6. A wireless communication method carried out by a wireless communication system including a plurality of base stations, one or more terminal, and one or more toll center, the wireless communication method comprising:
calculating a required radio quality;
selecting candidates for a combination of an accommodating base station and a communication scheme;
with respect to all of the candidates for a combination,
a first calculation of power consumption by transmitted radio waves;
a second calculation of power consumption by an analog circuit;
a third calculation of power consumption by digital signal circuitry performing digital signal processing;
a fourth calculation of a sum of power consumption by an entire network from results of the first, second, and third calculations;
recording a result of the fourth calculation step with respect to all of the candidates for a combination;
selecting the combination that minimizes the power consumption by the entire network from a result of the recording; and
implementing wireless communication using the selected combination.

7. A wireless communication controller that controls a wireless communication system including a plurality of base stations and one or more terminal, the wireless communication control device being configured to perform:
selecting candidates for a combination of an accommodating base station and a communication scheme;
calculating, with respect to all of the candidates for a combination, a sum of power consumption by an entire network calculated by the accommodating base station;
recording a result of the calculating with respect to all of the candidates for a combination;
selecting the combination that minimizes the power consumption by the entire network from a result of the recording; and
implementing wireless communication using the selected combination.

8. A non-transitory storage medium storing a computer readable wireless communication program to be executed by one or more arithmetic processor of a wireless communication controller that controls a wireless communication system including a plurality of base stations and one or more terminal,
the wireless communication program causing the wireless communication controller to perform:
of selecting candidates for a combination of an accommodating base station and a communication scheme;
calculating, for each candidate for a combination, a sum of power consumption by an entire network;
recording a result of the calculating with respect to all of the candidates for a combination;
selecting the combination that minimizes the power consumption by the entire network from a result of the recording processing; and
implementing wireless communication using the selected combination.
